(19) United States
(12) Patent Application Publication
(10) Pub. No.: US 2021/0300680 A1
(43) Pub. Date: Sep. 30, 2021

(54) PERPETUAL INVENTORY MANAGEMENT SYSTEM

(71) Applicant: Freetail Technologies Ltd., Bnei-Brak (IL)

(72) Inventor: Arye LEVIN, Bnei-Brak (IL)

(73) Assignee: Freetail Technologies Ltd., Bnei-Brak (IL)

(21) Appl. No.: 17/264,896

(22) PCT Filed: Jul. 29, 2019
(86) PCT No.: PCT/IL2019/050857

§ 371 Date: Feb. 1, 2021

(30) Foreign Application Priority Data
Aug. 1, 2018 (IL) 260949

(51) Int. Cl. B65G 1/137; G08B 13/196; G06Q 10/08

(52) U.S. Cl. CPC B65G 1/137; G08B 13/19632; B65G 2203/041; G08B 13/19641; G06Q 10/087; G08B 13/19669

(57) ABSTRACT

A kit to retrofit shelves with a perpetual inventory management system includes a plurality of panels and a standalone computing device electrically connected to the plurality of panels and configured to receive data from the plurality of panels. Each panel of the plurality includes a two dimensional array of distance sensors, an integrated circuit (IC), an input electrical connector, an output electrical connector; and a substrate on which the two dimensional array of distance sensors, the IC, the input electrical connector and the output electrical connector are mounted.

### RELATED APPLICATION

This application claims the benefit of priority from Israel Patent Application No. 260949 filed on Aug. 1, 2018, the contents of which are incorporated herein by reference in their entirety.

### FIELD AND BACKGROUND OF THE INVENTION

The present invention, in some embodiments thereof, relates to inventory management and, more particularly, but not exclusively, to an inventory management system for perpetually monitoring inventory on shelves.

Retail stores typically offer an abundance of different products for customer selection and purchase. The different products may be positioned on shelves and the shelves may be arranged in aisles. Customers may walk down the aisles, remove products of their choice from the shelves and bring the selected products to a point of sale in the store. One of the challenges in the retail business is in maintaining a full stock of all the different products available for sale on their shelves. Another challenge is maintaining all the products in their designated locations in the face of customers that may occasionally misplace products that they previously selected and then returned to another shelf. Continuous monitoring may be needed to overcome these challenges and such monitoring may come at a cost of man power.

There is a number of perpetual inventory management systems that attempt to reduce the man power required to monitor inventory on shelves and improve stock maintenance. The systems typically include sensors positioned on the shelves or otherwise in the store that automatically detect when a product is removed from a shelf. The information is forwarded to staff in the retail store based on which products may be replenished on the shelves. It is also known to use perpetual inventory management information for automating purchase, checkout, and payment steps associated with a retail transaction in the retail store. The effectiveness of perpetual inventory management systems may typically be based on accuracy and cost effectiveness.

### SUMMARY OF THE INVENTION

According to an aspect of some embodiments of the present invention there is provided perpetual inventory management system that monitors shelf inventory with improved accuracy and reduced cost. According to some example embodiments, the perpetual inventory management system includes at least one panel including a two dimensional (2D) array of distance sensors, a camera and an integrated circuit (IC). The IC may be configured to control operation of the panel and to communicate with a central processing unit by wired or wireless connection and may also be connected to a power supply. According to some example embodiments, the 2D array of distance sensors provide a topographical map of the shelf to perpetual monitor items on the shelf at low power expenditure while the camera is configured to be operated on demand whenever an event of interest is detected based on output from the 2D array of distance sensors.

According to an aspect of some embodiments of the present invention, the perpetual inventory management system is configured to be a modular system that may be easily adapted on site to different size shelves and different size aisles. In some example embodiments, the panel is configured to be cut on site to adapt the size of the panel and the size of the 2D array to different size shelves. The panels may be connected in series to span a length of an aisle including multiple shelves. Connection between the panels may provide for transmitting power and data along the connected panels to a power supply and central processing unit at designated location in the aisle.

According to an aspect of some example embodiments, there is provided a kit configured to retrofit shelves with a perpetual inventory management system, the kit comprising: a plurality of panels, wherein each panel of the plurality comprises: a two dimensional array of distance sensors; an integrated circuit (IC); an input electrical connector; an output electrical connector; and a substrate on which the two dimensional array of distance sensors, the IC, the input electrical connector and the output electrical connector are mounted; and a standalone computing device configured to be electrically connected to the plurality of panels and to receive data from the plurality of panels.

Optionally, at least one of the plurality of panels comprises a camera mounted on the substrate between an area spanning the two dimensional array of distance sensors and an edge of the panel.

Optionally, the plurality of panels is configured for interconnecting based on connecting the input electrical connector of one of the plurality of panels to the output electrical connectors another other of the plurality of panels.

Optionally, the input electrical connector of one of the plurality of panels is configured to physically lock into the output electrical connector of another of the plurality of panels.

Optionally, the standalone computing device is configured to be electrically connected to the plurality of panels based on connecting the input electrical connector of a first of the plurality of panels to the standalone computing device.

Optionally, the panel is configured to be cut at designated locations to accommodate placing the panel on different sized shelves, wherein cutting at designated locations reduces the size of the 2D array.

Optionally, the substrate is a flexible printed circuit board.

Optionally, the panels are configured to be powered with an external power source.

Optionally, the kit further comprises a plurality of fasteners configured to fasten the plurality of panels to ceilings of shelves.

Optionally, the distance sensors are photoelectric sensors or ultrasound based sensors configured to sense distance based on a time of flight of an emitted signal.

According to an aspect of some example embodiments, there is provided a sensing panel for perpetual inventory management of a shelf the panel comprising: a two dimensional array of distance sensors; an integrated circuit (IC); an input electrical connector; an output electrical connector, wherein the input electrical connector and the output electrical connector are configured to electrically interconnect with neighboring panels and thereby establish a serial communication channel between them; and a substrate on which the two dimensional array of distance sensors, the IC, the input electrical connector and the output electrical connector are mounted.

Optionally, the panel further comprises a camera wherein the camera mounted on the substrate between an area spanning the two dimensional array of distance sensors and an edge of the panel.

Optionally, the camera has a field of view of at least 160 degrees.

Optionally, the IC is configured to: sample outputs from two dimensional array of distance sensors in real time; identify a change in the outputs based on comparing current outputs with previously sampled outputs; determine direction of the change; and provide a command to activate a camera based on determining that the direction of the change indicates an increase in inventory on the shelf.

Optionally, the IC is configured to transmit data to external computing device based on detecting the change.

Optionally, the distance sensors are photoelectric based sensors or ultrasound based sensors configured to sense distance based on a time of flight of an emitted signal.

Optionally, the substrate is a flexible printed circuit board.

Optionally, the panel is configured to be powered via an external power source.

According to an aspect of some example embodiments, there is provided a method to perpetually monitoring inventory on a shelf, the method comprising: capturing topographical data of shelf space with a 2D array of distance sensors positioned above a shelf, wherein the capturing is performed perpetually; comparing topographical data captured in subsequent sampling events; detecting a change in the topographical data captured; determining if the change is due to an item being removed from the shelf; triggering activation of a first camera to capture an image of the shelf based on detecting the change and determining that the change is not due to an item being removed from the shelf; and transmitting captured topographical data to a computing device based on the detecting the change; transmitting captured image based on triggering the first camera; and determining a change in the shelf inventory based data transmitted.

Optionally, the method includes triggering activation of a second camera to capture a second image of the shelf based on detecting the change.

Optionally, the first camera and the second camera have overlapping field of views.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic drawing of an example panel in accordance with some example embodiments;

FIG. 2 is a simplified schematic drawing of shelves installed with example panels and an exemplary field of view of a camera on a panel in accordance with some example embodiments;

FIG. 3 is a is a simplified schematic drawing of an aisle include a plurality of example panels that are electrically connected in accordance with some example embodiments;

FIGS. 4A and 4B are schematic drawings showing two configurations for establishing electrical connection between panels in accordance with some example embodiments;

FIG. 5 is a simplified block diagram of an example perpetual inventory management system in accordance with some example embodiments;

FIG. 6 is a simplified block diagram of an example kit configured for retrofitting shelves in a retail environment with a perpetual inventory management system in accordance with some example embodiments;

FIG. 7 is a simplified flow chart of an example method to monitor inventory on a shelf in accordance with some example embodiments; and

FIG. 8 is a simplified flow chart of an example method to install the perpetual inventory management system in accordance with some example embodiments.

### DESCRIPTION OF SPECIFIC EMBODIMENTS OF THE INVENTION

The present invention, in some embodiments thereof, relates to inventory management and, more particularly, but not exclusively, to an inventory management system for perpetually monitoring inventory on shelves.

According to some example embodiments, there is provided a perpetual inventory management system that includes a plurality of interconnected panels each panel configured to be installed on a ceiling above a shelf including inventory and to monitor inventory on that shelf in real time. The plurality of interconnected panels may be connected to a remote power source based on which the panels are powered and may be connected to a standalone computing device or controller.

According to some example embodiments, each panel includes a 2D array of distance sensors that together sense topographical data and an IC configured to control operation of the panel and its communication with the standalone computing device. The 2D array of distance sensors are configured to be low power sensors that may be formed from a plurality of photoelectric sensors or ultrasound transducers. The panel may be formed with a substrate such as for example a flexible printed circuit board (PCT) on which the distance sensors and IC may be mounted. In some examples, size of the panel is less than that of the shelf and more than one panel is spread over the shelf to cover a footprint of the shelf. Optionally, a panel may be 20 cm-1 m in width and between 30 cm-60 cm in length.

The panel may also include an input electrical connector and an output electrical connector based on which the panels may be interconnected. Optionally, connection is based on fitting a male connector into a female connector. In some example embodiments, at least a portion of the panels additionally includes a camera configured to capture an image of the shelf and surrounding area on demand. Optionally, the IC is configured to detect a change in topography based on output from the distance sensors, to determine if the change is due to an item being removed from the shelf and to selectively activate the camera based on the change not being due to an item being removed from the shelf. The topography data and image data when captured may be transmitted to the standalone computing device based on detecting the change. The standalone computing device may perform further processing of the data and also communicate with other computing devices to obtain further data and information that may be used together with the data transmitted by the panels to control inventory in the retail store. Optionally, the standalone computing device or central computing device may transmit a command to one or more panels to capture more images or to perform other functions. Optionally, communication between the standalone computing device typically positioned on an aisle of shelves and a central computing device may be by wireless communication.

According to some example embodiments, the perpetual inventory management system is a versatile system that may be easily adapted to different retail environments. In some example embodiments, each of the panels may be cut to size of the shelf on site at defined locations indicated on the panel without damaging functionality of the panel. Interconnection between the panels may provide power to all the interconnected panels based on for example connecting power at one point. In a similar manner, the interconnections provide wired communication between each of the panels and the standalone computing device based on a one point connection. The IC on each panel are configured to control transfer of power and data between the panels and to perform some of the data processing. Optionally, data and power transfer between panels may be based on serial communication protocol or other protocol. More robust processing may be performed by the standalone computing devices and the central computing device. According to some example embodiments, perpetual inventory management system may be received as a kit including a plurality of panels with cameras and also without cameras and at least one standalone computing device. Optionally, the kit may additionally include connectors for electrically connecting the panels to each other and the power source and standalone computing device. Optionally, the kit includes screws or clasp for mounting the panel on a ceiling of a shelf.

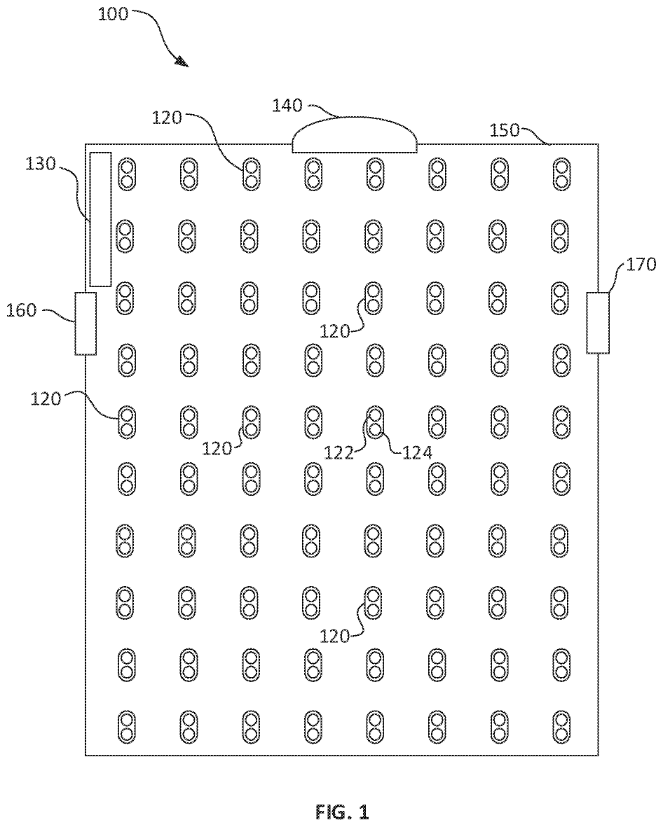

Referring now to the drawings, FIG. 1 shows a simplified schematic drawing of an example panel in accordance with some example embodiments. A panel 100 may be configured to monitor topography of a shelf in real time and identify a change in the topography. Topography data may be based on a 2D array of distance sensors 120 that are configured to detect distance to the shelf or to an object or item on the shelf at a plurality of designated points defined by the 2D array. Density of the 2D array may be for example 0.2 to 5 sensors per 1 cm². Distance sensors 120 may be selected to be relatively low cost and low power sensors. In some example embodiments, distance sensor 120 may be a photoelectric sensor that emits light, e.g. in the infrared range with a light emitting diode or laser 122 and detects reflection with a detector 124. Optionally, sensing may be based on light detection and ranging (LIDAR) technology. Alternately distance sensor 120 may be an ultrasound sensor. The distance may be determined based on time of flight.

According to some example embodiments, an IC 130 included in panel 100 may control operation of the 2D array of distance sensors 120 and may process output from distance sensors 120. IC 130 may for example simultaneously sample output from the 2D array of distance sensors 120 at a rate of 5-50 times per second, e.g. 30 times per second. Optionally, IC 130 includes memory capability, e.g. buffer memory. In some example embodiments, IC 130 is configured to construct a topographical map from the output and compare sequential outputs from the 2D array of distance sensors 120. Alternatively, IC 130 may compare raw data between subsequent sampling events without constructing a map. Panel 100 may additionally include an input electrical connector 160 and an output electrical connector 170 via which electrical communication is established with additional panels 100, with an external power source and with one or more external computing devices. IC 130 may be configured to control electrical communication via input electrical connector 160 and output electrical connector 170.

According to some example embodiments, panel 100 includes a camera 140 that may be selectively activated by IC 130 on demand. Optionally camera 140 is configured to have a relatively wide field of view and is positioned to capture an image of both the shelf below as well as the volume in front of the shelf, e.g. a shelf across or customers standing in front of the shelves. In some example embodiments, IC 130 is configured to activate camera 140 whenever a change in topography is detected by 1C 130 and whenever a command from an external computing device is received by IC 130. In some example embodiments, IC 130 activates camera 140 whenever the change in topography indicates an increase in inventory on the shelf and does not activate the camera when the change in topography indicates a decrease in inventory. A decrease in inventory may typically be due to removal of an item that was previously on the shelf and this event may be identified based on tomography data without image data. Alternatively when an item is added to the shelf, it may be difficult to predict what item was added and image data may help identify the item.

IC 130 controls transmitting output from camera 140 via output electrical connector 170 to an external computing device. In some example embodiments, the combined operation of the 2D array of distance sensors 120 and camera 140 provides for monitoring shelf inventory in real time without the need to transfer large amount of data to a central processing unit. Optionally, IC 130 only transmits data when a change in topography is detected. Additionally, since camera 140 is only activated occasionally, power consumption rate of panel 100 may be maintained at a relatively low level and the processing required to monitor may also be conserved. In some example embodiments, camera 140 is selected to be monochrome to reduce the amount of data collected and transmitted.

According to some example embodiments, panel 100 is formed from relatively thin substrate 150 such as a flexible printed circuit board that may be fitted on existing shelves in a retail store without altering the shelves.

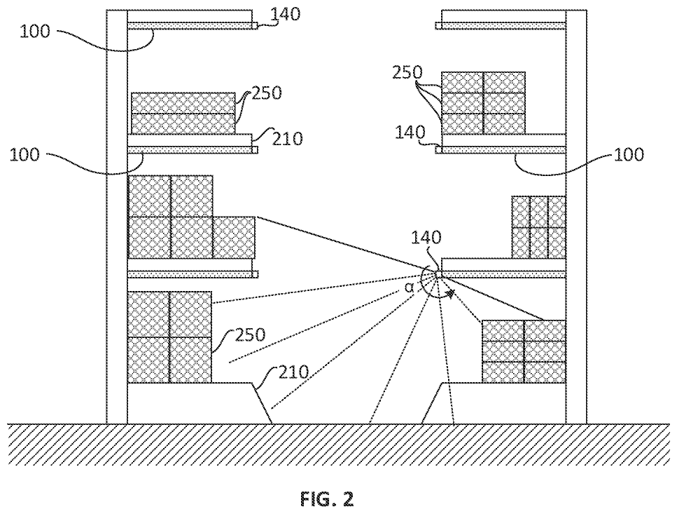

FIG. 2 shows a simplified schematic drawing of shelves installed with example panels and an exemplary field of view of a camera on a panel in accordance with some example embodiments. Panel 100 may be installed under one or more shelves 210 that are configured to hold inventory such as objects 250 or on a ceiling of one or more shelves 210. Objects 250 may vary in shape and size. Panel 100 is positioned under a shelf 210 so that camera 140 is on an outer edge of shelf 210. Optionally, only some panels 100 may include camera 140 while others may not. In some example embodiments, camera 140 may have a field of view, a, of 100-180 degrees, e.g. 160-180 degrees or 180 degrees. Optionally, camera 140 is positioned so that its field of view spans shelf 210 below camera 140 as well as shelves 210 across from camera 140. Optionally, cameras 140 are configured to have overlapping field of views and a central computing device may combine information from a plurality of cameras 140 to obtain remote information regarding an area in the retail store.

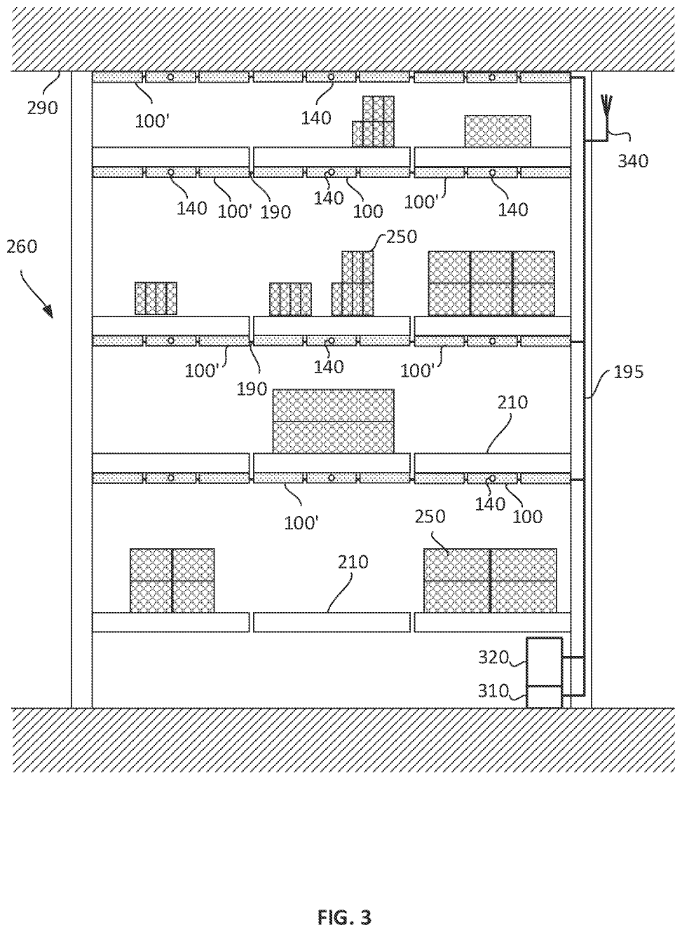

FIG. 3 shows a simplified schematic drawing of an aisle include a plurality of example panels that are electrically connected in accordance with some example embodiments. According to some example embodiments, each of a plurality of panels 100 including a camera and panels 100′ excluding the camera installed in an aisle 260 of a retail store may be electrically connected to each other optionally with a connector 190 and also connected via a central line 195 to a power source 310 and local computing device 320. Panels 100 and 100′ may be installed on a bottom of a shelf 210 and may also be installed on a ceiling 290 to monitor the topmost shelf. In some example embodiments, each shelf 210 includes at least one panel 100 with a camera and optionally additional panels 100′ without a camera. Optionally 2-5 panels may span a footprint of a shelf depending on the size of the shelf and the size of the panel.

Power source 310 may be for example an electrical outlet. Local computing device 320 may have processing ability and memory. In some example embodiments, local computing device 320 may receive input from a plurality of panels 100 and 100′ by wired communication and forward the input to a central computing device or other computing device based on wirelessly, e.g. with an antenna 340. Furthermore, local computing device 320 may receive input, e.g. commands from central computing device or other computing device and may communicate that input to one or more panels 100 and/or 100′ or adjust its operation based on the input or commands.

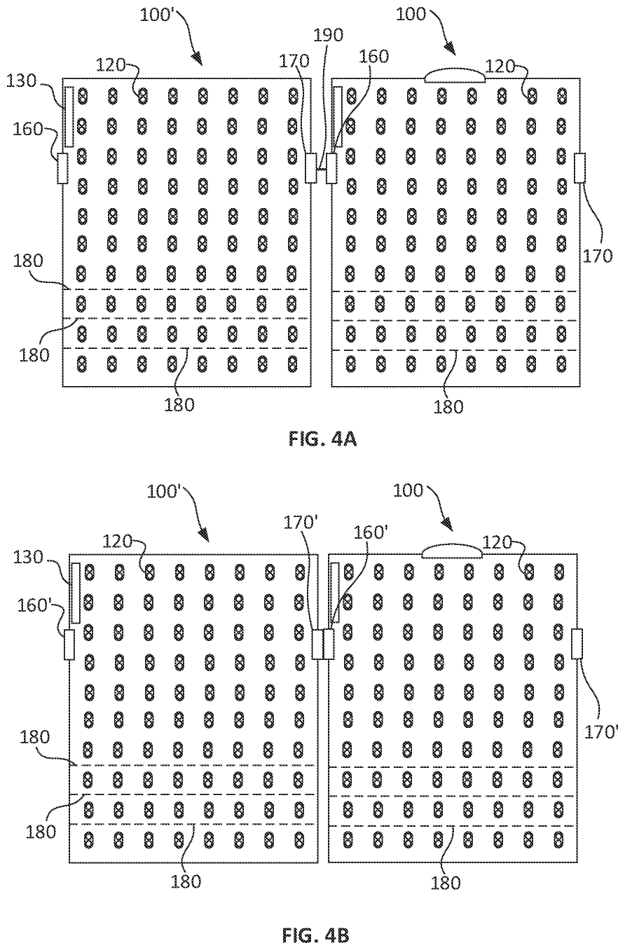

FIGS. 4A and 4B show schematic drawings showing two configurations for establishing electrical connection between panels in accordance with some example embodiments. In some example embodiments, panels 100 may be electrically connected with a wired connection 190. Wired connection 190 may provide for transmitting data and power between panels 100. The wired connection may be between an input electrical connector 160 of one panel 100 and an output electrical connector 170 of another panel 100 (FIG. 4A). In other example embodiments, input electrical connector 160 and output electrical connector 170 may be configured to interlock, e.g. based on a male to female connection as shown in FIG. 4B so that additional hardware, e.g. wire 190 is not required and the panels may be closely spaced to one another.

According to some example embodiments, panel 100 may be cut to fit different sized shelves. Optionally, cutting panel 100 may lead to discarding some of the distance sensors 120. In some example embodiments, panel 100 includes one or more indications 180 showing where the panel may be cut. Panel 100 is configured to operate even when cut along one of the indicating lines 180. Optionally, IC 130 is configured to detect a break in the circuit due to cutting and to adapt operation of the panel.

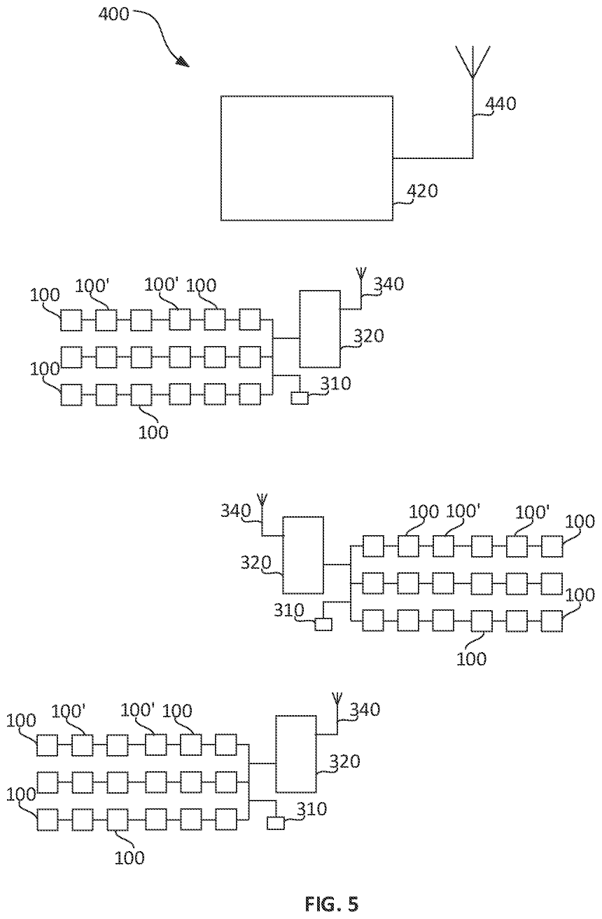

FIG. 5 shows a simplified block diagram of an example perpetual inventory management system in accordance with some example embodiments. According to some example embodiments, the perpetual inventory management system 400 provides management in a retail store with a plurality of aisles, each have a plurality of shelves. According to some example embodiments, each of a plurality of panels 100 (and panels 100′) arranged in an aisle is electrically connected to each other and also to a local computing device 320 and power source 310. More than one panel may be used to monitor each shelf. Power source 310 may be an outlet or a dedicated power source. Both power and data may run along the plurality of panels so that only a single point of contact to power source 310 and local computing device 320 may be needed. This simplifies the installation and reduces the number of wires that need to run along the aisles. Local computing device 320 may communicate with other local computing devices 320 and with a central computing device 420 via wired connection or via a wireless communication channel with antennas 340 and 440. Central computing device 420 may include software that may collect information received from the various panels and apply that information together with additional data to monitor inventory on the shelves. Central computing device 420 may communicate with other handheld computing devices that may be applied to manage inventory in the retail environment. Local computing device 320 may be configured to perform basic processing of the local data received from the plurality of panels 100 in a specific aisle, while the central computing device 420 may perform additional processing and may integrate information received from a plurality of local computing devices 320 with other data available, e.g. from a planogram and a data base of available products.

In some example embodiments, local computing device 320 or central computing device 420 may apply thresholding to alert staff that the product is running out based on the topographical data received. Thresholding may be based on number of products missing, number of products on the shelf or a ratio between them. When a defined threshold is past, an alert may be communicated to the staff.

In some example embodiments, central processing unit 420 may define priority at which shelves are to be restocked and the staff may be alerted based on the both topography data and the defined priority.

In some example embodiments, the topography data may be applied to collect statistics regarding time of day that the inventory is being expended, rate and quantity at which the inventory is being expended.

If a customer misplaces an object on a shelf, the topographical data together with data from the camera may be used to determine what product was added to the shelf. In some example embodiments, based on a change in the topographical map, a central computing device may determine a shape of the object and suggest possible products that may fit that shape. Final recognition may be supported based on image recognition from the camera data. Staff may be alerted.

In some examples, the perpetual inventory management system is applied for automated buying, inventory refill, statistic on buying habits and also to monitor performance of workers.

Optionally, perpetual inventory management system may be integrated with a system that tracks the buyers in the store. The perpetual inventory management system may also record how long a person inspects a product before putting it back on the shelf

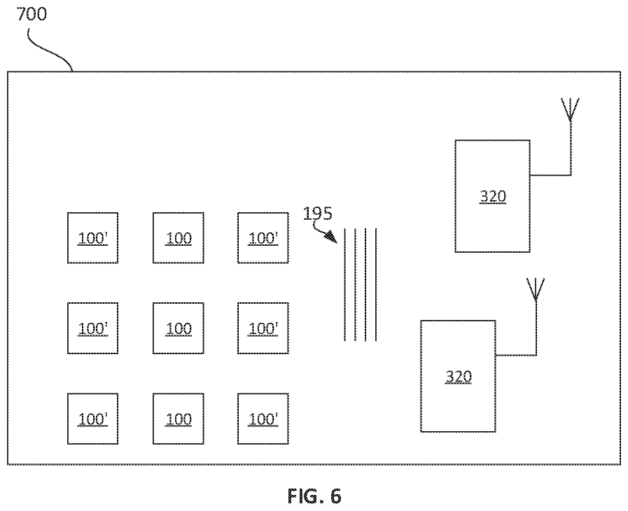

FIG. 6 shows a simplified block diagram of an example kit configured for retrofitting shelves in a retail environment with a perpetual inventory management system in accordance with some example embodiments. According to some example embodiments, a kit 700 for retrofitting shelves in a retail environment with a perpetual inventory management system includes a plurality of panels 100 including cameras and panels 100′ not including cameras and one or more local computing devices 320. Optionally, kit 700 additionally includes hardware 195 for making wired connections. In some example embodiments, kit 700 may also include a variety of screws or double sided taped dedicated for connecting panels to a ceiling of a shelf. Panels 100 (and 100′) may be installed on ceilings of existing shelves and may be connected to local computing devices 320 and power outlet by wired connection.

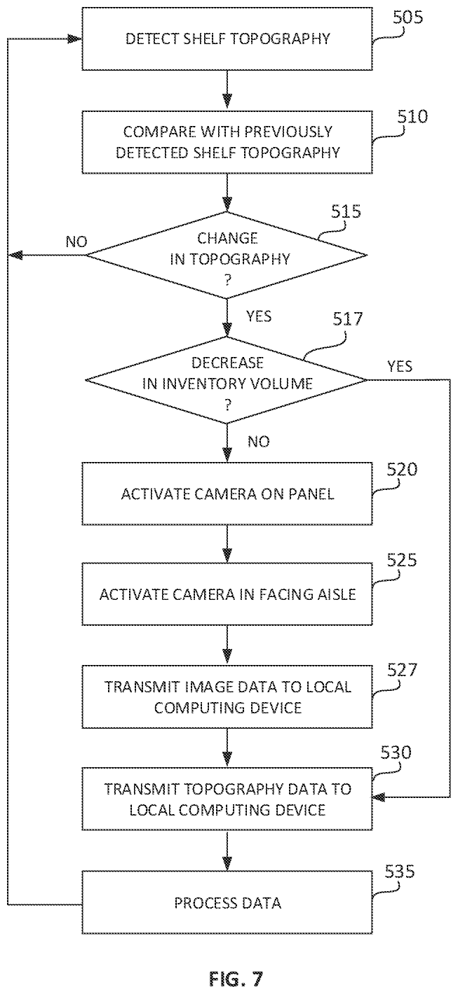

FIG. 7 shows a simplified flow chart of an example method to monitor inventory on a shelf in accordance with some example embodiments. According to some example embodiments, a 2D array of distance sensors captures a topographical image representation of a shelf (block 505). The 2D array of distance sensors may be configured to sample output at a relatively high frequency, e.g. 5-50 frames per second or 30 frames per second so that real time information may be obtained. According to some example embodiments, topography captured is compared with a previous topography or optionally an average of a plurality of topographies previously captured (block 510). Optionally, the IC included in the panel is configured to store previous data captured over one or more sampling periods and compare with a current set of data. When a change is detected (block 515), the IC may determine if the change due to an increase or decrease in items positioned on the shelf (block 517). When the change is not due to a decrease, IC may activate the camera on the panel (block 520) and may also transmit a command to a central or local processing unit to additionally activate a camera in a facing aisle (block 525). Topographical data from the 2D array of distance sensors may be transmitted to the local computing device whenever a change in topography is detected (block 530). Image data may be transmitted whenever the IC captured image data, e.g. with an item was added to the shelf (block 527). The data transmitted may be processed to identify the event that occurred (block 535). Based on the data received by the central processing unit, commands may be transmitted from the central processing unit to the panels. Optionally, a command to capture more images with cameras in the vicinity may be communicated or a command to transmit additional topographical data may be communicated. Based on information received by the central processing unit, the system may identify when an item is removed from a shelf, when an item is placed on a shelf and may identify the item. Optionally, an item that is placed on the shelf may be identified based on topographical data and image data while an item removed from the shelf may be identified based on topographical data without requiring image data.

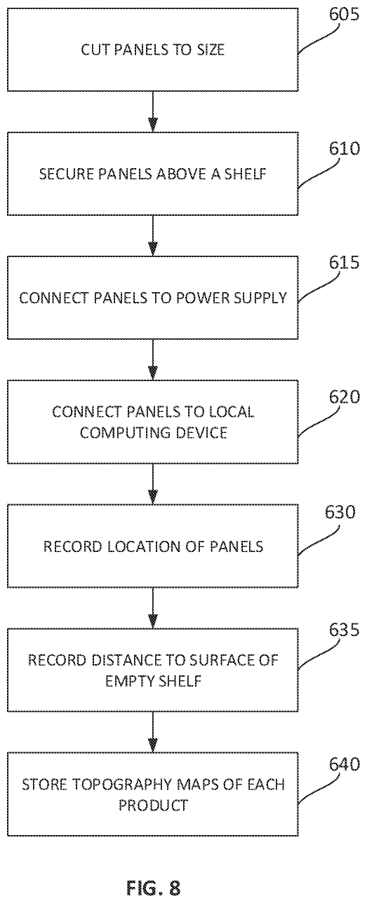

FIG. 8 is a simplified flow chart of an example method to install the perpetual inventory management system in accordance with some example embodiments. According to some example embodiments, the perpetual inventory management system maybe received as a kit including a plurality of panels, a plurality of local computing device and software. According to some example embodiments, the panels may be received in a standard size and may be cut as needed to accommodate different size shelves, e.g. shelves with different depths (block 605). The panels may then be secured above the shelves that are to be monitored (block 610). The panels may be secured with double sided tape, screws or hooks on to a ceiling of a shelf formed by an upper shelf or by a ceiling of the premise. Optionally, the kit includes dedicated screws or clasps for securing the panels.

The panels may be powered by connecting to an outlet positioned on the aisle (block 615). Optionally, a row of panels may be electrically connected and power from an outlet may be received via one panel and transmitted to the other panels. In a similar manner, a row of panels may also be connected to a local computing device situated per aisle (block 620). The local computing device may include wireless communication capability to communicate with a central computing device. The central computing device may include planogram software as well as other software and data for managing shelf inventory. Location and identity of each panel included in the system may be determined (block 630). According to some example embodiments, the 2D array of distance sensors may be calibrated based capturing topographical data of the shelf that is empty and relating the data to a measured distance between the panel and the shelf. This information may be stored for future reference (block 635). Optionally, a topographical data for each product may be recorded with the panel and stored for future reference to help identify an item that is misplaced on a shelf (block 640).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

In addition, any priority document(s) of this application is/are hereby incorporated herein by reference in its/their entirety.

1. A kit configured to retrofit shelves with a perpetual inventory management system, the kit comprising:
a plurality of panels, wherein each panel of the plurality comprises:
a two dimensional array of distance sensors;
an integrated circuit (IC);
an input electrical connector;
an output electrical connector; and
a substrate on which the two dimensional array of distance sensors, the IC, the input electrical connector and the output electrical connector are mounted; and
a standalone computing device configured to be electrically connected to the plurality of panels and to receive data from the plurality of panels.

2. The kit according to claim 1, wherein at least one of the plurality of panels comprises a camera mounted on the substrate between an area spanning the two dimensional array of distance sensors and an edge of the panel.

3. The kit according to claim 1, wherein the plurality of panels is configured for interconnecting based on connecting the input electrical connector of one of the plurality of panels to the output electrical connectors another other of the plurality of panels.

4. The kit according to claim 3, wherein the input electrical connector of one of the plurality of panels is configured to physically lock into the output electrical connector of another of the plurality of panels.

5. The kit according to claim 1, wherein the standalone computing device is configured to be electrically connected to the plurality of panels based on connecting the input electrical connector of a first of the plurality of panels to the standalone computing device.

6. The kit according to claim 1, wherein the panel is configured to be cut at designated locations to accommodate placing the panel on different sized shelves, wherein cutting at designated locations reduces the size of the 2D array.

7. The kit according to claim 1, wherein the substrate is a flexible printed circuit board.

8. The kit according to claim 1, wherein the panels are configured to be powered with an external power source.

9. The kit according to claim 1, comprising a plurality of fasteners configured to fasten the plurality of panels to ceilings of shelves.

10. The kit according to claim 1, wherein the distance sensors are photoelectric sensors or ultrasound based sensors configured to sense distance based on a time of flight of an emitted signal.

11. A sensing panel for perpetual inventory management of a shelf the panel comprising:
a two dimensional array of distance sensors;
an integrated circuit (IC);
an input electrical connector;
an output electrical connector, wherein the input electrical connector and the output electrical connector are configured to electrically interconnect with neighboring panels and thereby establish a serial communication channel between them; and
a substrate on which the two dimensional array of distance sensors, the IC, the input electrical connector and the output electrical connector are mounted.

12. The sensing panel according to claim 11, comprising a camera wherein the camera mounted on the substrate between an area spanning the two dimensional array of distance sensors and an edge of the panel.

13. The sensing panel according to claim 12, wherein the camera has a field of view of at least 160 degrees.

14. The sensing panel according to claim 11, wherein the IC is configured to:
sample outputs from two dimensional array of distance sensors in real time;
identify a change in the outputs based on comparing current outputs with previously sampled outputs;
determine direction of the change; and
provide a command to activate a camera based on determining that the direction of the change indicates an increase in inventory on the shelf.

15. The sensing panel according to claim 14, wherein the IC is configured to transmit data to external computing device based on detecting the change.

16. The sensing panel according to claim 11, wherein the distance sensors are photoelectric based sensors or ultrasound based sensors configured to sense distance based on a time of flight of an emitted signal.

17. The sensing panel according to claim 11, wherein the substrate is a flexible printed circuit board.

18. The sensing panel according to claim 11, wherein the panel is configured to be powered via an external power source.

19. A method to perpetually monitoring inventory on a shelf, the method comprising:
capturing topographical data of shelf space with a 2D array of distance sensors positioned above a shelf, wherein the capturing is performed perpetually;
comparing topographical data captured in subsequent sampling events;
detecting a change in the topographical data captured;
determining if the change is due to an item being removed from the shelf;
triggering activation of a first camera to capture an image of the shelf based on detecting the change and determining that the change is not due to an item being removed from the shelf; and
transmitting captured topographical data to a computing device based on the detecting the change;
transmitting captured image based on triggering the first camera; and
determining a change in the shelf inventory based data transmitted.

20. The method according to claim 19, comprising triggering activation of a second camera to capture a second image of the shelf based on detecting the change.

21. The method according to claim 20, wherein the first camera and the second camera have overlapping field of views.

22. The method according to claim 19, comprising identifying when an item has been added or removed from the shelf based on the image data and topographical data.
